(19) United States
(12) Patent Application Publication
(10) Pub. No.: US 2015/0015185 A1
(43) Pub. Date: Jan. 15, 2015

(54) Cut-off Structure of a Charger

(71) Applicant: Ming-Sheng Lin, Kaohsiung City (TW)

(72) Inventor: Ming-Sheng Lin, Kaohsiung City (TW)

(21) Appl. No.: 13/938,292

(22) Filed: Jul. 10, 2013

(51) Int. Cl. H02J 7/00

(52) U.S. Cl. CPC H02J 7/0036
USPC 320/107

(57) ABSTRACT

A cut-off structure of a charger contains a power supply unit and a cutting-off set. The power supply unit includes a voltage converting portion, a connector member, and an extension cord connecting with the voltage converting portion and the connector member. The voltage converting portion has a transforming coil for transforming mains electricity into a charging voltage. The cutting-off set includes a controlling head, a control switch, and a control wire coupling with the controlling head and the control switch. The control switch is fixed on the connector member, and the voltage converting portion is disposed on the controlling head. After removing the connector member, the mains electricity cannot conduct to the power supply unit via the controlling head. After the connector member is inserted to an electronic device, the control switch is triggered so that the relay circuit conducts with a mains power cable.

### FIELD OF THE INVENTION

The present invention relates to a charging structure of an electronic device, and more particularly to the charging structure which is cut off after removing a connector member from the electronic device.

### BACKGROUND OF THE INVENTION

Electronic devices, such as, mobile media, mobile phones, notebook computers, and tablet PCs, are widely used by people in daily life. The operating voltages of the electronic devices are supplied by rechargeable batteries stored in the electronic devices. A conventional charging structure contains a power supply unit having an exposed plug connecting with a connector member via an extension cord, such that in a charging process, the plug is inserted on a socket of mains electricity, and the connector member is inserted into a port of an electronic device so that indoor power is transformed into a charging voltage, thus charging the electronic device.

However, after the charging process, the connector member is removed from the electronic device, but the power supply unit is still inserted on a socket of the mains electricity, thus losing electricity of the electronic device. The present invention has arisen to mitigate and/or obviate the afore-described disadvantages.

### SUMMARY OF THE INVENTION

The primary object of the present invention is to provide a cut-off structure of a charger which is cut off after removing a connector member from the electronic device.

To obtain the above objectives, a cut-off structure of a charger includes a fixing plate having a body.

a power supply unit and a cutting-off set. The power supply unit includes a voltage converting portion, a connector member, and an extension cord connecting with the voltage converting portion and the connector member. The voltage converting portion has a transforming coil for transforming mains electricity into a charging voltage. The cutting-off set includes a controlling head, a control switch, and a control wire coupling with the controlling head and the control switch. The control switch is fixed on the connector member, and the voltage converting portion is disposed on the controlling head. After removing the connector member, the mains electricity cannot conduct to the power supply unit via the controlling head. After the connector member is inserted to an electronic device, the control switch is triggered so that the relay circuit conducts with a mains power cable.

Preferably, the controlling head has a relay circuit, and the control wire is electrically connected with the relay circuit.

Preferably, the control switch series connects with the mains power cable.

Preferably, the power supply unit is one piece with the cutting-off set.

### BRIEF DESCRIPTION OF THE DRAWINGS

FIG. 1 is a diagram showing the exploded components of a cut-off structure of a charger according to a first embodiment of the present invention.

FIG. 2 is a diagram showing a power supply unit connecting with a cutting-off set of the cut-off structure of the charger according to the first embodiment of the present invention.

FIG. 3 is a diagram showing the operation of the cut-off device of the charger according to the first embodiment of the present invention.

FIG. 4 is a diagram showing the assembly of a cut-off structure of a charger according to a second embodiment of the present invention.

FIG. 5 is a diagram showing the assembly of a cut-off structure of a charger according to a third embodiment of the present invention.

### DETAILED DESCRIPTION OF THE PREFERRED EMBODIMENTS

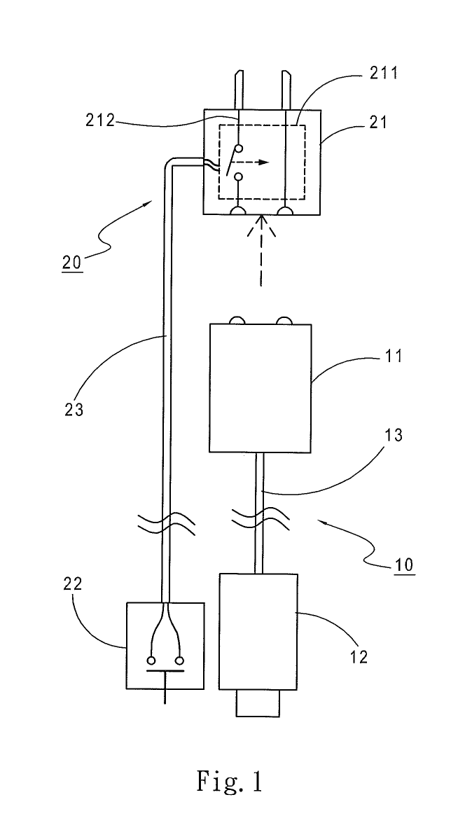

FIG. 1 is a diagram showing the exploded components of a cut-off structure of a charger according to a first embodiment of the present invention. A cut-off structure of a charger of the first embodiment comprises a power supply unit 10 and a cutting-off set 20. The power supply unit 10 includes a voltage converting portion 11, a connector member 12, and an extension cord 13 connecting with the voltage converting portion 11 and the connector member 12; the voltage converting portion 11 has a transforming coil for transforming mains electricity into a charging voltage; the connector member 12 is a USB connector for matching with a port of an electronic device; wherein an output voltage and a connector member of the voltage converting portion 11 are designed based on using requirement. The cutting-off set 20 includes a controlling head 21, a control switch 22, and a control wire 23 coupling with the controlling head 21 and the control switch 22; the controlling head 21 is formed in a plug shape for being inserted on a socket of the mains electricity and has a relay circuit 211 and a mains power cable 212 for connecting with the mains electricity, wherein when the controlling head 21 is not used, the mains power cable 212 is in an on state; the control switch 22 is a pressure switch or a limit switch for changing circuit on/off state, and the control switch 22 is series connected with the control wire 23; the control wire 23 is electrically connected with the relay circuit 211 and is modulated by the control switch 22, such that the relay circuit 211 changes a connecting state of the mains power cable 212. It is to be noted that between the voltage converting portion 11 and the controlling head 21 is defined an electrical connection structure, such as a plug and a socket for mating with the plug, a projection and a concaved hole for cooperating with the projection, hence the mains electricity is conducted to the power supply unit 10 from the cutting-off set 20.

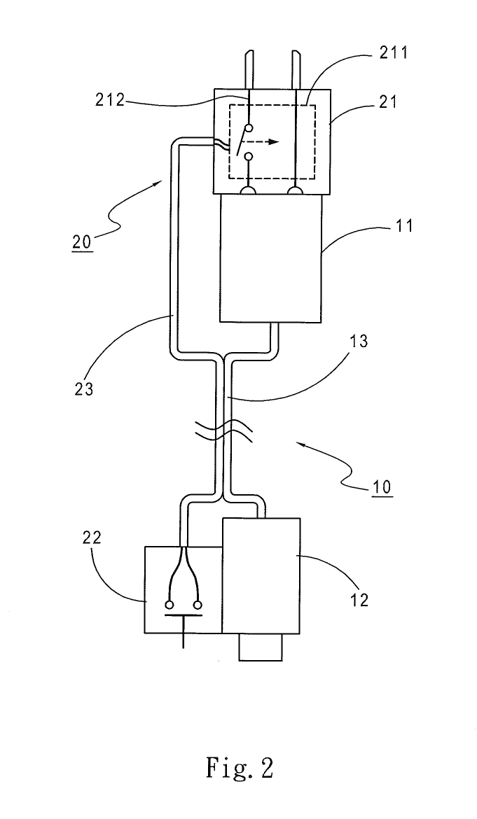

FIG. 2 is a diagram showing the power supply unit connecting with the cutting-off set of the cut-off structure of the charger according to the first embodiment of the present invention. The control switch 22 is fixed on the connector member 12. The voltage converting portion 11 is disposed on the controlling head 21. Although the controlling head 21 can be inserted on the socket of the mains electricity, since the connector member 12 is not connected with the electronic device, the control switch 22 cannot be started. The mains power cable 212 of the relay circuit 211 is in the on state, i.e., the mains electricity cannot conduct to the power supply unit 10 via the controlling head 21, hence a mains power supply is cut off so as to prevent energy from loss.

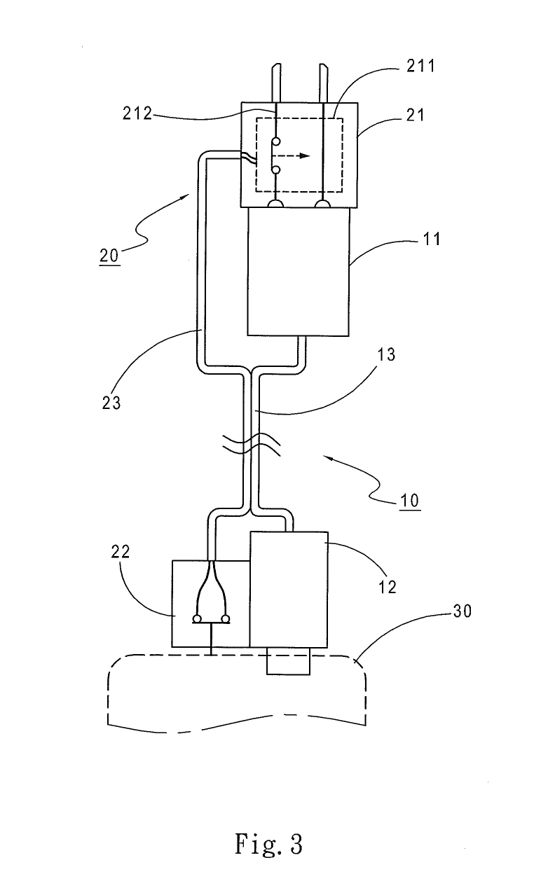

FIG. 3 is a diagram showing the cut-off structure of the charger connecting with the electronic device according to the first embodiment of the present invention. After the connector member 12 is inserted to the electronic device 30, the control switch 22 is triggered so that the relay circuit 211 conducts with the mains power cable 212, such that the mains electricity is supplied to the voltage converting portion 11 so as to charge the electronic device 30. As shown in FIG. 3, the control switch 22 is in an off state, yet it can be designed in various arrangements based on using requirement.

Also, the power supply unit 10 and the cutting-off set 20 can be one piece.

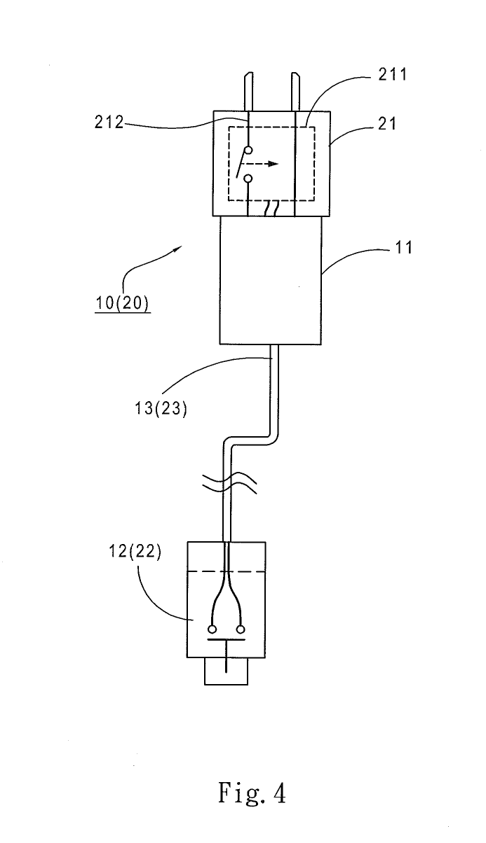

FIG. 4 is a diagram showing the assembly of a cut-off structure of a charger according to a second embodiment of the present invention. A difference of a cut-off structure of the second embodiment from that of the first embodiment comprises: a control switch 22 made in one piece with a connector member 12, a control wire 23 made in one piece with an extension cord 13, and a controlling head 21 made in one piece with a voltage converting portion 11.

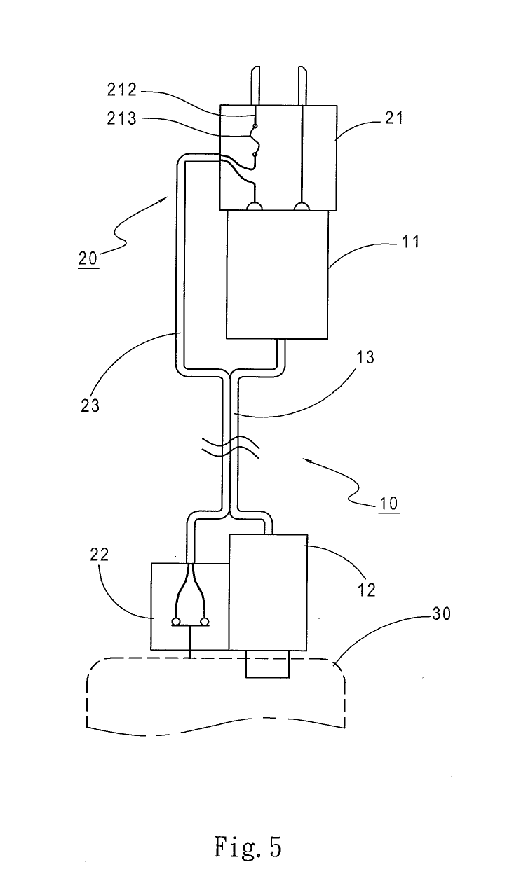

FIG. 5 is a diagram showing the assembly of a cut-off structure of a charger according to a third embodiment of the present invention. A difference of a cut-off structure of the third embodiment from that of the first embodiment comprises: a control switch 22 series connecting with a mains power cable 212, such that when the connector member 12 is inserted to the electronic device 30, the control switch 22 is in an off state so that the main electricity conducts to the power supply unit 10; when the connector member 12 is removed from the electronic device 30, the control switch 22 is in an on state so as to stop supplying the mains electricity. To enhance a safety of the cut-off structure, a fuse 213 is mounted on the mains power cable 212.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A cut-off structure of a charger comprising a power supply unit and a cutting-off set;
the power supply unit including a voltage converting portion, a connector member, and an extension cord connecting with the voltage converting portion and the connector member; the voltage converting portion having a transforming coil for transforming mains electricity into a charging voltage; the cutting-off set including a controlling head, a control switch, and a control wire coupling with the controlling head and the control switch; the control switch being fixed on the connector member, and the voltage converting portion being disposed on the controlling head; after removing the connector member, the mains electricity cannot conduct to the power supply unit via the controlling head; after the connector member is inserted to an electronic device, the control switch is triggered so that the relay circuit conducts with a mains power cable.

2. The cut-off structure of the charger as claimed in claim 1, wherein the controlling head has a relay circuit, and the control wire is electrically connected with the relay circuit.

3. The cut-off structure of the charger as claimed in claim 1, wherein the control switch series connects with the mains power cable.

4. The cut-off structure of the charger as claimed in claim 1, wherein the power supply unit is one piece with the cutting-off set.
